(19) United States
(12) Patent Application Publication
(10) Pub. No.: US 2026/0121970 A1
(43) Pub. Date: Apr. 30, 2026

(54) ROUTING NETWORK FOR SUPERCONDUCTING DEVICES USING RACE LOGIC

(71) Applicant: THE REGENTS OF THE UNIVERSITY OF CALIFORNIA, Oakland, CA (US)

(72) Inventors: Georgios Michelogiannakis, Berkeley, CA (US); Darren Lyles, San Ramon, CA (US); Dilip Vasudevan, Emeryville, CA (US); Patricia Gonzalez-Guerrero, Naperville, IL (US); Meriam Bautista, Katy, TX (US)

(21) Appl. No.: 18/559,193

(22) PCT Filed: May 10, 2022
(86) PCT No.: PCT/US2022/028538

§ 371 Date: Nov. 6, 2023

Related U.S. Application Data
(60) Provisional application No. 63/187,805, filed on May 12, 2021.

(51) Int. Cl. H04L 45/24; H04L 47/62

(52) U.S. Cl. CPC H04L 45/24; H04L 47/6225

(57) ABSTRACT

An apparatus is provided. The apparatus includes a routing network to route packets between a set of sending devices and a set of receiving devices. One or more of the routing network, the set of sending devices, and the set of receiving devices are part of a superconducting device. The set of sending devices and the set of receiving devices use a race logic architecture. The apparatus also includes a scheduling module to interconnect different subsets of the set of sending devices to different subsets of the set of receiving devices based on a set of connection schedules. The packets are routed between the different subsets of the set of sending devices and the different subsets of the set of receiving devices based on the set of connection schedules.

### CROSS-REFERENCE TO RELATED APPLICATIONS

This application claims the benefit of U.S. Provisional Application No. 63/187,805, filed on May 12, 2021, the entire content of which is hereby incorporated by reference herein.

### STATEMENT OF GOVERNMENT RIGHTS

This invention was made with government support under Contract No. DE-AC02-05CH11231 awarded by the U.S. Department of Energy. The government has certain rights in the invention.

### TECHNICAL FIELD

Aspects of the present disclosure relate to routing data, and in particular, to routing data in superconducting systems, devices, chips, or circuits.

### BACKGROUND

Superconductivity is defined as the property of certain metals to have zero resistance below a critical temperature that is usually a few degrees Kelvin. superconducting devices, chips, systems, etc., may be computing devices, processing devices, etc., that operate at those temperatures. Josephson junctions (JJ) are often used in superconducting devices. JJs have two edges and allow current to pass through with no resistance until a critical current is reached. Reaching that critical current causes the JJ to switch to a resistive state and emit a magnetic quantum flux transfer that is observable as a voltage pulse. JJs are capable of switching with delays as low as a few picoseconds and with energies several orders of magnitude lower than traditional CMOS circuits.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an example system, in accordance with some embodiments of the disclosure.

FIG. 2 is a block diagram illustrating an example windows for a routing network, in accordance with some embodiments of the disclosure.

FIG. 3 is a block diagram that illustrates an example routing network, in accordance with some embodiments of the disclosure.

FIG. 4 is a block diagram illustrating an example routing device, in accordance with some embodiments of the disclosure.

FIG. 5 is a block diagram illustrating an example scheduling device, in accordance with some embodiments of the disclosure.

FIG. 6 is a block diagram illustrating an example scheduling device, in accordance with some embodiments of the disclosure.

FIG. 7 is a block diagram illustrating an example balancer, in accordance with some embodiments of the disclosure.

FIG. 8 is a block diagram illustrating an example converter, in accordance with some embodiments of the disclosure.

FIG. 9 is a block diagram illustrating an example converter, in accordance with some embodiments of the disclosure

FIG. 10 is a block diagram illustrating an example converter, in accordance with some embodiments of the disclosure.

FIG. 11A is a diagram illustrating an example shift register, in accordance with some embodiments of the disclosure.

FIG. 11B is a diagram illustrating an example shift buffer, in accordance with some embodiments of the disclosure.

FIG. 12 is a flow diagram of a method of routing packets/pulses, in accordance with some embodiments of the disclosure.

### DETAILED DESCRIPTION

As discussed above, Josephson junctions (JJ) are often used in superconducting devices. JJs make superconducting devices particularly attractive for energy-efficient computation even after accounting for cooling energy. Superconducting circuits have been shown to operate at clock frequencies of several tens of GHz. However, the density of JJs in an area is less than the density of traditional CMOS circuits.

A single flux quantum (SFQ) superconducting device may encode a logical 1 with the presence of a pulse that typically has a duration of a few picoseconds and an amplitude of few ms. A logical 0 is encoded by the absence of a pulse. This is in contrast with CMOS where 0s and 1s are encoded by voltage levels that typically remain constant until the next rising clock edge. Recently, race logic (RL) was adapted to rapid single flux quantum (RSFQ) superconducting circuits. Since in RSFQ voltage pulses continuously propagate and thus do not maintain a constant voltage level at each input like in CMOS, race logic in RSFQ adapts its logic primitives (i.e., gates) to be stateful in order to remember what pulses arrived and their timing relative to other inputs of the same gate. RL encodes information in the time domain by dividing time in what we refer to as “time slots.” The time of arrival of a pulse encodes its value. Although superconducting devices may use race logic (e.g., a temporal based encoding) traditional routing networks still used a binary based encoding and thus are hard to use with superconducting devices

Aspects of the disclosure address the above-noted and other deficiencies by providing a routing network where both the data and control paths operate in a temporal domain. The routing network may use a predefined schedule or timetable to couple different senders to different receivers. The schedules or timetables allow the routing network to be more easily compatibly with senders and receivers that use race logic, due to the temporal nature of the schedules/timetables. This allows the superconducting device to operate more quickly and/or efficiently as packets, pulses, data, etc., can be remain in a race logic encoding and do not need to be converted to a binary encoding.

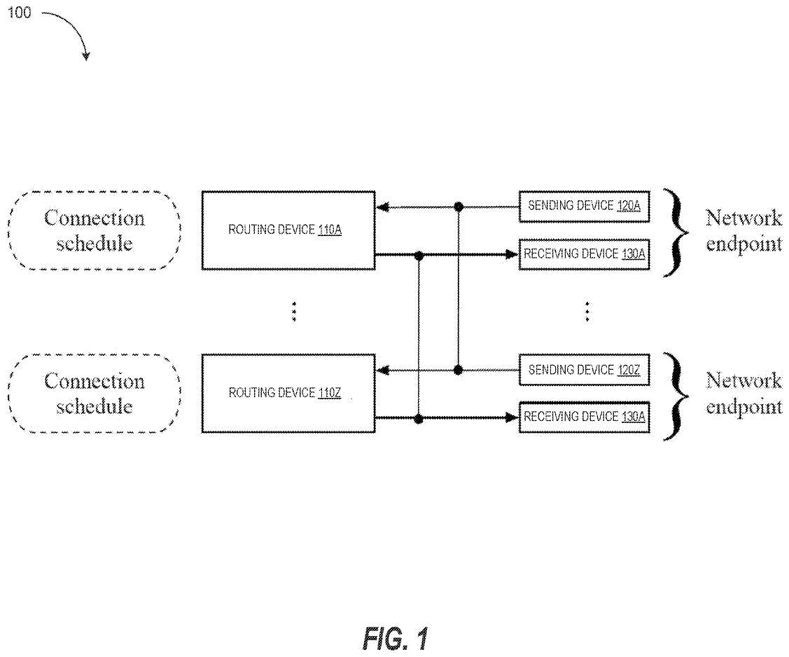

FIG. 1 is a block diagram illustrating an example system 100, in accordance with some embodiments of the disclosure. The system 100 includes routing devices 110A through 110Z, sending devices 120A through 120Z, and receiving devices 130A through 130Z. Each sending device 120A through 120Z may be referred to as a sender, a transmitter, etc. Each receiving device 130A through 130Z may be referred to as a receiver. In one embodiment, the system 100 may be a single flux quantum (SFQ) chip or circuit. For example, the system 100 may be a rapid SFQ (RSFQ) chip, circuit, device, system, etc. The system 100 (e.g., the sending devices 120A through 120Z, the receiving devices 130A through 130Z, etc.) may use a race logic architecture or convention.

In one embodiment, the routing devices 110A through 110Z may receive data from the sending devices 120A through 120Z (as illustrated by the leftward arrows). The routing devices 110A through 110Z may forward the data to the receiving devices 130A through 130Z (as illustrated by the rightward arrows). In some embodiments, each routing device 110A through 110Z may be coupled to different subsets of the sending devices 120A through 120Z and different subsets of the receiving devices 130A through 130Z. In other embodiments, each routing device 110A through 110Z may be connected to each sending device 120A through 120Z and to each receiving device 130A through 130Z. Any number or variation of routing devices, sending devices, and receiving devices may be used in different embodiments.

In one embodiment, the routing devices 110A through 110Z may be a network-on-chip (NoC). For example, the routing devices 110A through 110Z may be a superconducting rotary NoC (SRNOC). The routing devices 110A through 110Z may also be referred to as a routing network, a connection network, etc. The sending devices 120A through 120Z and receiving devices 130A through 130Z may also be referred to as endpoints of the routing network.

In one embodiment, both the data path (e.g., the interconnections between the sending devices 120A through 120Z, and the receiving devices 130A through 130Z) and the control path (e.g., the connection schedules, how the routing devices 110A through 110Z interconnect the sending devices 120A through 120Z and receiving devices 130A through 130Z) may operate in a temporal domain using race logic. This allows the routing devices 110A through 110C to be compatible with architectures that already implement or use race logic. In addition, because RSFQ devices may have lower device density (e.g., can fit fewer devices, circuits, in an area), the routing devices 110A through 110C may reduce the number of devices used in the RSFQ device.

Each routing devices 110A through 110Z may use a connection schedule to interconnect a sending device with a routing device. For example, each routing device 110A through 110Z may have its own connection schedule indicating when a particular sending device should be connected to a particular receiving device. The connection schedule may be a predefined or fixed schedule. Using a predefined or fixed schedule may allow for simpler control logic because the connections between sending devices and receiving devices are not established and terminated ad hoc.

In one embodiment, the routing devices 110A through 110Z, sending devices 120A through 120Z, and receiving devices 130A through 130Z may be coupled to a common clock (e.g., a clock device, a timing circuit, etc.). The common block may serve as a timing reference such that all components are aware of which connections are active at any one time and connections are established or torn down (e.g., disconnected) in synchrony with other routing devices.

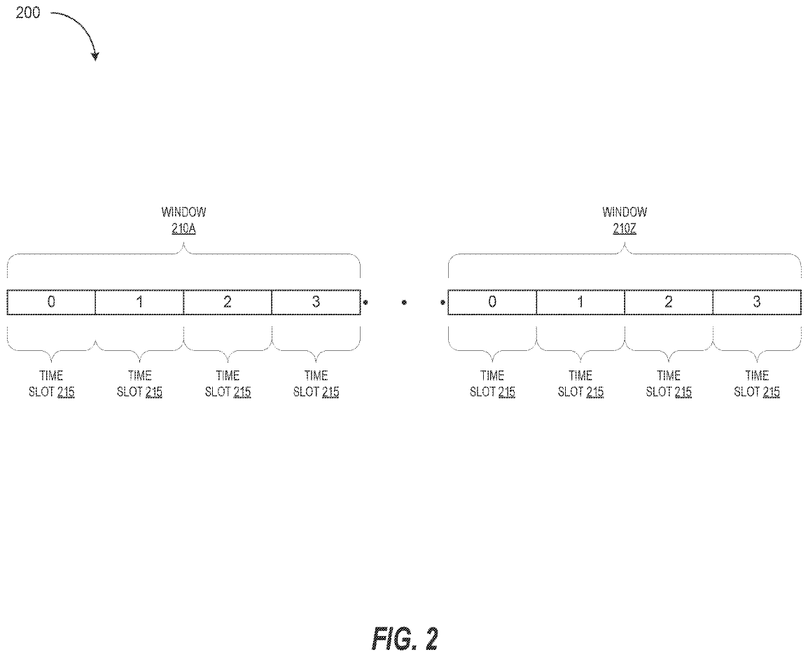

FIG. 2 is a block diagram illustrating an example windows 210A through 210Z for a routing network, in accordance with some embodiments of the disclosure. Each of windows 210A through 210Z includes four time slots 215. Although each windows 210A through 210Z is described as having four time slots 215 in FIG. 2, a window may include any number of time slots in other embodiments. For example, each window may include 4, 8, 32, or any appropriate number of time slots. Furthermore, the number of windows for the routing network vary in different embodiments. For example, there may be 2, 4, 8, 100, or any appropriate number of windows. The windows may also be referred to as connection windows.

As discussed above, the endpoints (e.g., sending device and receiving devices) of a routing network (e.g., routing devices 110A through 110Z illustrated in FIG. 2, a NoC, a SRNoC, etc.) may use a race logic architecture or race logic convention. A race logic convention may operate in a manner such that the time of arrival of a pulse, signal, etc., determines the value it encodes. For example, each time slot 215 has an associated value of 0, 1, 2, or 3. If a pulse is received at the first time slot 215 (in a window 210), the value of the pulse is 0. If a pulse is received at the second time slot 215 (in a window 210), the value of the pulse is 1. If a pulse is received at the third time slot 215 (in a window 210), the value of the pulse is 2. If a pulse is received at the fourth time slot 215 (in a window 210), the value of the pulse is 4. Each pulse that travels through routing network may be an independent packet (e.g., data, a data packet, etc.).

In one embodiment, multiple pulses may be received during a window 210A through 210Z. For example, during window 210A, a first pulse may be received at the first time slot 215, a second pulse may be received at the second time slot 215, a third pulse may be received at the third time slot 215, and a fourth pulse may be received at the fourth time slot 215. Thus, four separate values, 0, 1, 2, and 3 were received during window 210A. In another example, during window 210C, a first pulse may be received at the first time slot 215, a second pulse may be received at the third time slot 215, and a third pulse may be received at the fourth time slot 215. Thus, three separate values, 0, 2, and 3 were received during window 210C.

A particular sending device (e.g., an input to the routing network) may be coupled to (e.g., may be continuously connected to) a particular receiving device (e.g., an output for the routing network) for the duration of the window. For example, the same sending device may be coupled to the same receiving device via a routing device for the duration of a window 210A. The number of timeslots 215 in each window 210A through 210Z may be the same in some embodiments. Thus, each routing device (of the routing network) may couple a sending device to a receiving device for equal amounts of time.

In one embodiment, the number of time slots in a window may determine the number of equivalent binary bits that may be represented, encoded, etc., by a pulse, packet, etc. For example, if there are 64 time slots per window, each pulse/packet is equivalent to value that has log₂64 bits (e.g., each pulse represents a 6-bit value). By allowing each time slot 215 to carry a pulse/packet, the total number of bits of information/data that may be represented/encoded by the pulses may be determined as follows: ((log₂X)*X), where X is the number of slots in a window. Although the number of time slots may be illustrated as being a power of 2, the number of time slots may be any appropriate number in other embodiments.

In the routing network, the pulses/packets may not need to carry destination, virtual channel, head/tail bits (e.g., headers or footers), or any other overhead information traditionally found in traditional routing networks (e.g., traditional NoCs). Because the routing devices will connect/couple the appropriate senders and receivers (based on a schedule, a connection schedule, etc.), such overhead information (such as the destination) may not be need to route a pulse/packet from the appropriate sending device to the appropriate receiving device. In some embodiments, error correction information/data may be used if the system or architecture uses error correction. In order to increase the payload capacity (e.g., the number of bits that can be represented or encoded) of a single pulse, the number of time slots in a window 210A through 210Z can be increased.

To maintain the same notion of time throughout the network (e.g., to help keep the sending devices, receiving devices, and routing devices on substantially the same timing), time slots 215 may be long enough to account for the propagation delay through the routing network. Otherwise, a packet/pulse entering the routing network may arrive during a different time slot at the receiving endpoint, thus changing its value. Therefore, in the routing network, the duration of a time slot may be based on or may be determined by the propagation delay through the routing network. The propagation delay may also include the amount of time it may take to configure, setup, reset, etc., the routing devices of the routing network. For example, the amount of time for a routing device to disconnect from a first sending device and a first receiving device, and connect to a second sending device and a second receiving device may be factored into the propagation delay.

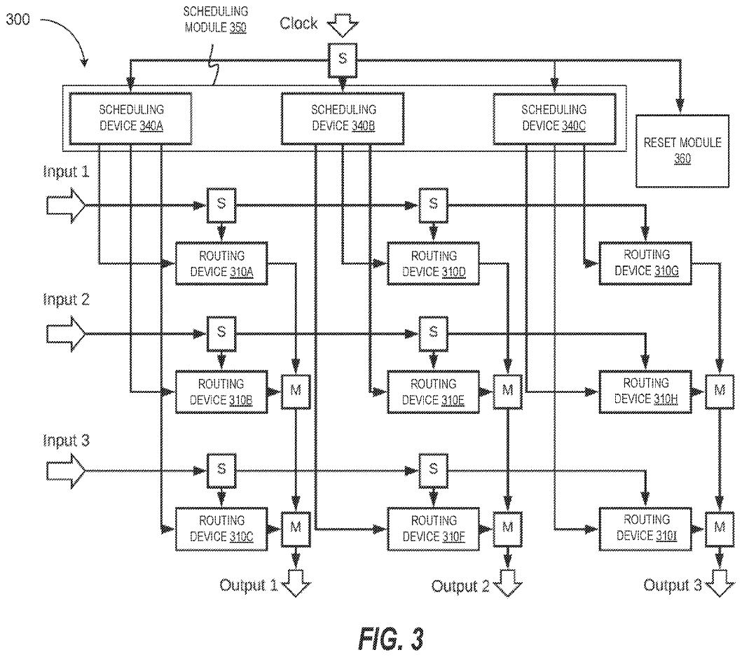

FIG. 3 is a block diagram that illustrates an example routing network 300, in accordance with some embodiments of the disclosure. The routing network 300 may be referred to as a NoC, a SRNoC, etc. The routing network 300 includes routing device 310A through 310I, scheduling module 350, splitters S, and mergers M. The routing devices 310A through 310I may also be referred to as crosspoints, crossbar crosspoints, etc. The routing network 300 may be a 3×3 routing network. For example, there routing network 300 includes a 3×3 arrangement of routing devices.

Each splitter S has an input and two (or more) outputs. Each splitter S may produce a pulse/packet at both outputs (or all of its outputs) when an input pulse/packet is received on its input. Each merger M has two (or more) inputs and one output. Each merger M may produce an output pulse when receiving a pulse at either input.

Scheduling module 350 may select, activate, etc., routing devices 310A through 310I based on one or more schedules. Scheduling module 350 includes scheduling deices 340A through 340C. Scheduling device 340A is coupled to routing devices 310A through 310C, scheduling device 340B is coupled to routing devices 310D through 310F, and scheduling device 340C is coupled to routing devices 310G through 310I. Each of the scheduling devices 340A through 340C has three outputs (e.g., a left, middle, and right output). The scheduling devices 340A through 340C may use one of the three outputs to select a routing device, as discussed in more detail below. The scheduling devices 340A through 340C may also be referred to as counting networks.

The routing network 300 is coupled to three different inputs, input 1, input 2, and input 3. Each of the inputs may be coupled to one or more sending devices (e.g., a transmitter, a sender, etc.) that may transmit pulses, packets, data, etc., via the routing network 300. The routing network 300 is also coupled to three different outputs, output 1, output 2, and output 3. Each of the outputs may be coupled to one or more receiving devices (e.g., a receiver) that may receive pulses, packets, data, etc., via the routing network 300.

The routing network 300 may route packets, pulses, data, etc., received from input 1 to one of output 1, output 2, or output 3, based on one or more connection schedules. For example, scheduling device 340A may select one of routing devices 310A through 310C to forward one or more pulses/packets based on a first connection schedule (e.g., may activate or may cause a routing device to forward data). Scheduling device 340B may select one of routing devices 310D through 310F to forward one or more pulses/packets based on a second connection schedule. Scheduling device 340C may select one of routing devices 310G through 310I to forward one or more pulses/packets based on a third connection schedule.

In one embodiment, the connection schedules may be round robin schedules. A round robin schedule may be a schedule that selects each routing device for an equal amount of time. For example, scheduling device 340A may select routing device 310A during a first window (using its first output), may select routing device 310B during a second window (using its second output), and may select routing device 310C during a third window (using its third output). In another example, scheduling device 340B may select routing device 310F during a first window (using its first output), may select routing device 310D during a second window (using its second output), and may select routing device 310E during a third window (using its third output). Thus, each scheduling device 340A through 340C may use its first output, second output, third output and then rotate back to using its first output. Based on the connection schedule, one routing device at each row and one routing device at each column receives a select signal (e.g., is activated) from the scheduling devices 340A through 340C during a window.

The scheduling devices 340A through 340C may receive a clock or clock signal from a clock/timing device. The clock signal may have a period that is equal to the amount of time for a window. This may allow the scheduling devices 340A through 340C to select a different routing device each window.

In one embodiment, the routing devices 310A through 310I may be reset at the end of each window (e.g., before the start of the next window). A reset signal may be generated by a reset module 360 to reset each of the routing devices 310A through 310I at the end of each window. The reset module 360 may be couple to each of the routing devices 310A through 310I to provide the reset signal to the routing devices 310A through 310I. The reset module 360 may be driven by the clock and may remain synchronized with the operation of the scheduling devices 340A through 340C.

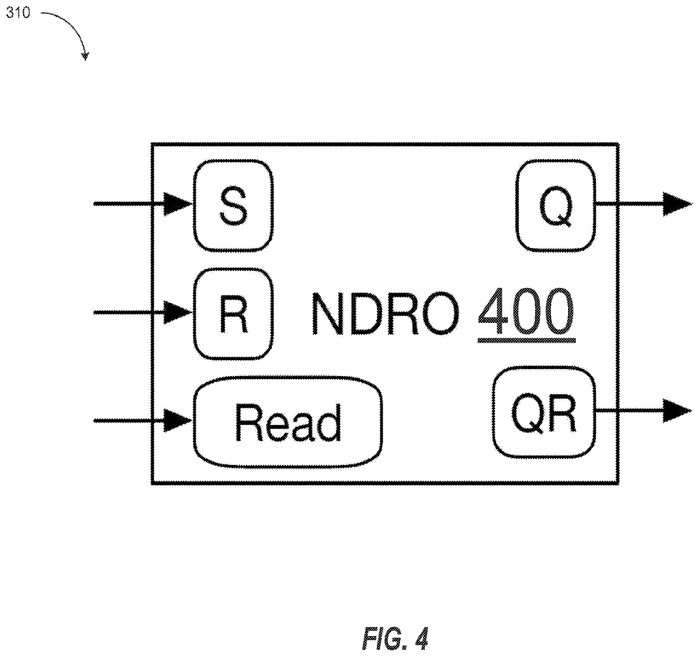

FIG. 4 is a block diagram illustrating an example routing device 310, in accordance with some embodiments of the disclosure. As illustrated in FIG. 4, a routing device 310 may be and/or may include a nondestructive read out (NDRO) cell 400. The NDRO cell 400 may include three inputs (S, Read, and R) and two outputs (Q and QR). As discussed above, a routing network may include multiple NDRO cells 400.

In one embodiment, the NDRO cell 400 may maintain internal state to remember pulses it observed from the reset (R) and select (S) inputs, and their relative timing. If the NDRO cell 400 observes a reset (R) pulse more recently than select (S), any pulses arriving to the data input (Read) are not routed to the data output (Q) because the NDRO is in a cleared state. However, if the select (S) input observes a pulse more recently than reset (R), the NDRO is in a “connected state” and thus any pulses arriving to the data input (the Read input) are routed to the data output (Q). The output QR produces a pulse when Q does not and vice versa. The output QR may not be used by the routing network. In one embodiment, the NDRO cell 400 operates correctly even with overlapping reset and select inputs. If there are overlapping reset and select inputs, the select input may take precedence.

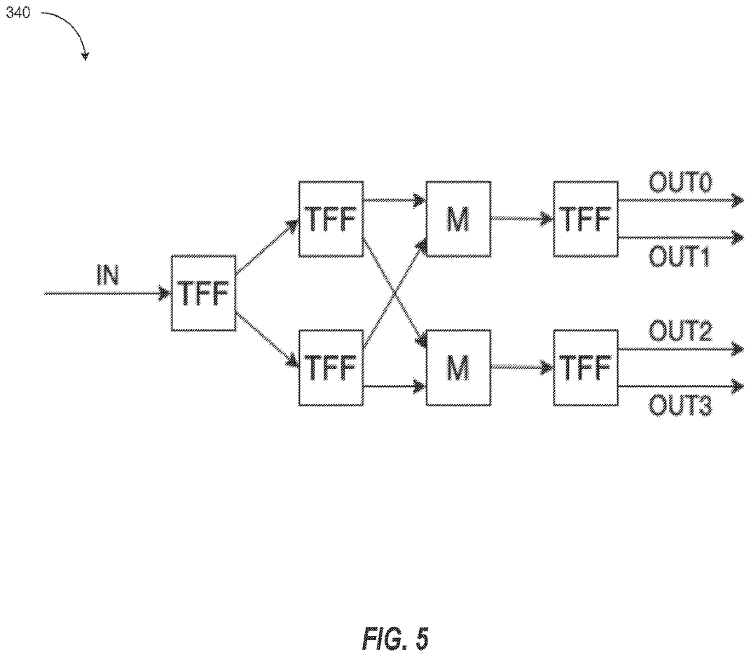

FIG. 5 is a block diagram illustrating an example scheduling device 340, in accordance with some embodiments of the disclosure. The scheduling device 340 includes toggle flip flops (TFFs) and mergers M. As discussed above, the scheduling device 340 may be coupled to a set of routing devices. The scheduling device 340 may select one of the routing devices by providing an output to a select input of the routing device. The scheduling device 340 may select the different routing devices based on a schedule, such as a round robin schedule. The selected routing device may route a pulse, packet, data, etc., from a sending device to a receiving device. The scheduling device 340 may also be referred to as a counting network. In one embodiment, the scheduling device 340 may be referred to as a 1×4 or 1-to-4 scheduling device (e.g., a device that has one input and four outputs).

As discussed above, the scheduling device 340 includes TFFs. The TFFs may also be referred to as balancers. A TFF has one input and two outputs (which may be referred to as Q and QR). When a pulse, signal, data, etc., arrives at the input, the TFF may transmit that pulse to the output Q (e.g., the first output). The TFF will transmit the next pulse that is received to output QR (e.g., the second output). The TFF will rotate between transmitting pulses (received via the input) using the output Q and the output QR. Each merger M has two inputs and one output. Each merger M may produce an output pulse when receiving a pulse at either input.

In one embodiment, the scheduling device 340 may implement the schedule (e.g., connection schedule, time table, connection timetable, etc.) for selecting different routing devices. As discussed above, the scheduling device 340 may receive a clock signal or clock pulse from a clock/timing device. All incoming pulses arrive through the input (IN) and get distributed evenly in a round-robin fashion to the N outputs (e.g., OUT0, OUT1, OUT2, and OUT3). For example, the first input pulse to arrive is routed to OUT0, the second input pulse to OUT1, and so on and so forth. After sending a pulse to OUT3, the scheduling device 340 may start back at OUT0 for the next pulse.

Although four outputs are shown, the scheduling device 340 may include any appropriate number of outputs in other embodiments. For example, the scheduling device 340 may include 8, 16, 30, or some other appropriate number of outputs. Additional TFFs and mergers M may be added to the scheduling device 340 to accommodate the additional output.

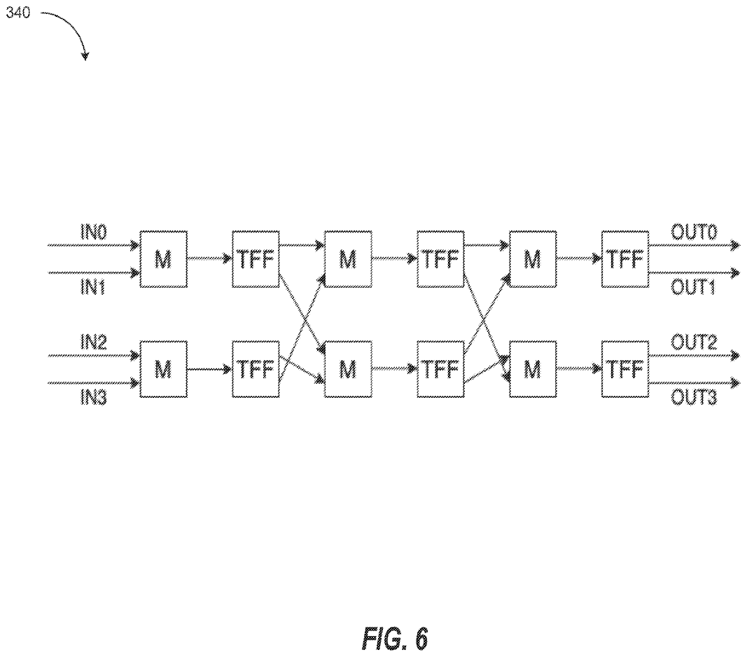

FIG. 6 is a block diagram illustrating an example scheduling device 340, in accordance with some embodiments of the disclosure. The scheduling device 340 includes toggle flip flops (TFFs) and mergers M. As discussed above, the scheduling device 340 may be coupled to a set of routing devices. The scheduling device 340 may select one of the routing devices by providing an output to a select input of the routing device. The scheduling device 340 may select the different routing devices based on a schedule, such as a round robin schedule. The selected routing device may route a pulse, packet, data, etc., from a sending device to a receiving device. The scheduling device 340 may also be referred to as a counting network. In one embodiment, the scheduling device 340 may be referred to as a 4×4 or 4-to-4 scheduling device (e.g., a device that has four inputs and four outputs).

As discussed above, the scheduling device 340 includes TFFs. The TFFs may also be referred to as balancers. The scheduling device 340 also includes mergers M.

In one embodiment, the scheduling device 340 may implement the schedule (e.g., connection schedule, time table, connection timetable, etc.) for selecting different routing devices. As discussed above, the scheduling device 340 may receive a clock signal or clock pulse from a clock/timing device. An incoming pulse arriving one of the N inputs (e.g., IN0, IN1, IN2, and IN3) may get distributed evenly in a round-robin fashion to the N outputs (e.g., OUT0, OUT1, OUT2, and OUT3). For example, the first input pulse to arrive (from one or inputs IN0 through IN3) is routed to OUT0, the second input pulse (from one or inputs IN0 through IN3) to OUT1, and so on and so forth. After sending a pulse to OUT3, the scheduling device 340 may start back at OUT for the next pulse.

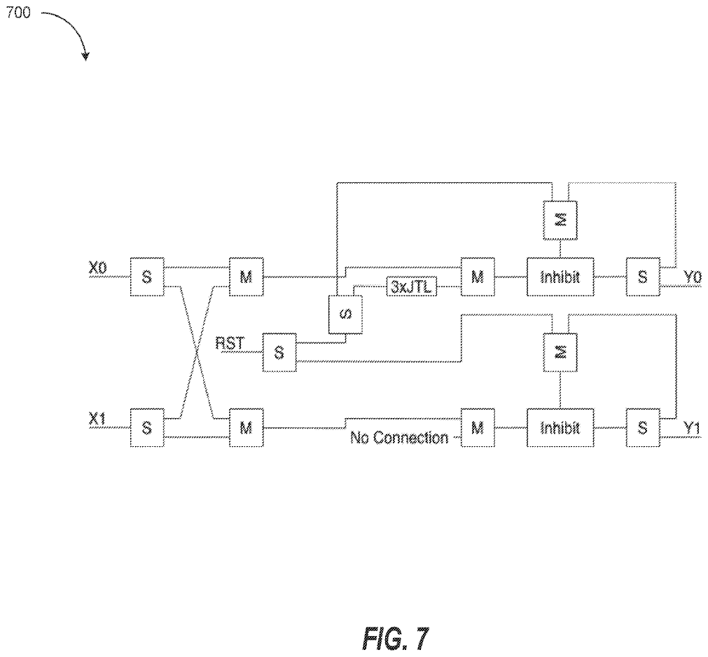

FIG. 7 is a block diagram illustrating an example balancer 700, in accordance with some embodiments of the disclosure. The balancer 700 may be part of a scheduling device (e.g., scheduling device 340 illustrated in FIG. 3). For example, rather than using a TFF in the scheduling device 340, the balancer 740 may be used. The balancer 700 includes inputs X0 and X1, and outputs Y0 and Y1.

The balancer 700 includes splitters, S, mergers M, Josephson transmission lines (JTLs), and inhibit circuits. Each splitter S has an input and two (or more) outputs. Each splitter S may produce a pulse/packet at both outputs (or all of its outputs) when an input pulse/packet is received on its input. Each merger M has two (or more) inputs and one output. Each merger M may produce an output pulse when receiving a pulse at either input. A JTL may include one input and one output. A JTL may propagates a pulse from an input to an output after a fixed delay. An inhibit circuit may include two inputs and one output. An inhibit circuit may propagate a pulse from the first input unless a pulse arrived at second input more recently than the first input.

As illustrated in FIG. 7, the outputs of the two right most splitters S are routed back to the balancer 700 to create feedback loops. The feedback loops allow the balancer 700 to configure the routing path. For example, when a pulse exits at output Y0, it will be fed back to the inhibit block, causing the path to be inhibited or closed, allowing the next pulse to exit at output Y1. The balancer 700 also includes a reset input to reset the balancer 700 back to an initial state.

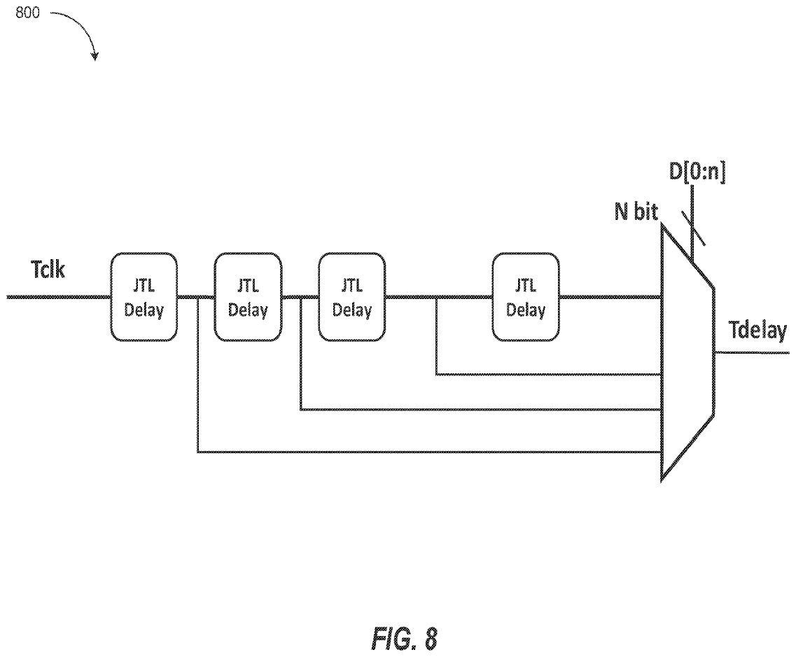

FIG. 8 is a block diagram illustrating an example converter 800, in accordance with some embodiments of the disclosure. As discussed above, one or more of the components in RSFQ superconducting circuit may use race logic, or some other temporal based encoding for data (e.g., an encoding where the number of pulses received during a period of time indicates a value). However, some of the components in the RSFQ superconducting circuit may not use race logic, or components coupled to the RSFQ superconducting circuit may not use race logic. For example, the sending devices may use race logic but the receiving devices may not use race logic. In another example, additional devices that are coupled to the receiving devices may not use race logic while the receiving devices use race logic.

In one embodiment, the converter 800 may convert a binary input into a race logic format or encoding. The converter 800 may include an input reference clock Telk which feeds into serially connected delay blocks (JTL Delay). The delay blocks may be implemented as a delay buffer or a two inverters in series. The output of each delay block is fed as input to the n:1 multiplexer. The select signal of the multiplexer is the digital input (e.g., a bit value) which converted to an output that confirms to race logic.

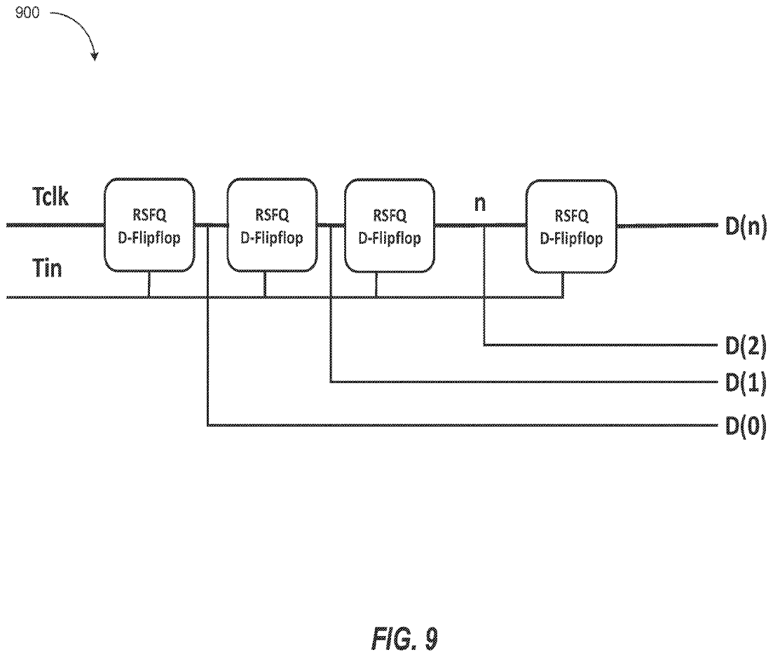

FIG. 9 is a block diagram illustrating an example converter 900, in accordance with some embodiments of the disclosure. As discussed above, one or more of the components in RSFQ superconducting circuit may use race logic, or some other temporal based encoding for data (e.g., an encoding where the number of pulses received during a period of time indicates a value). However, some of the components in the RSFQ superconducting circuit may not use race logic, or components coupled to the RSFQ superconducting circuit may not use race logic.

In one embodiment, the converter 900 may receive a pulse, packet, data, etc., that uses a race logic format or encoding at the input Tin. The converter 900 may convert the pulse/packet into a binary format. The converter 900 may include an input reference clock Telk which feeds into serially connected delay blocks. Each delay block uses a RFSQ D-flip flop (DFF). The output of each delay block is observed. The input reference clock Telk of all the RFSQ DFFs are connected to stop signal and the input of the first RFSQ DFF is connected to the start signal which is the time-domain signal Tin.

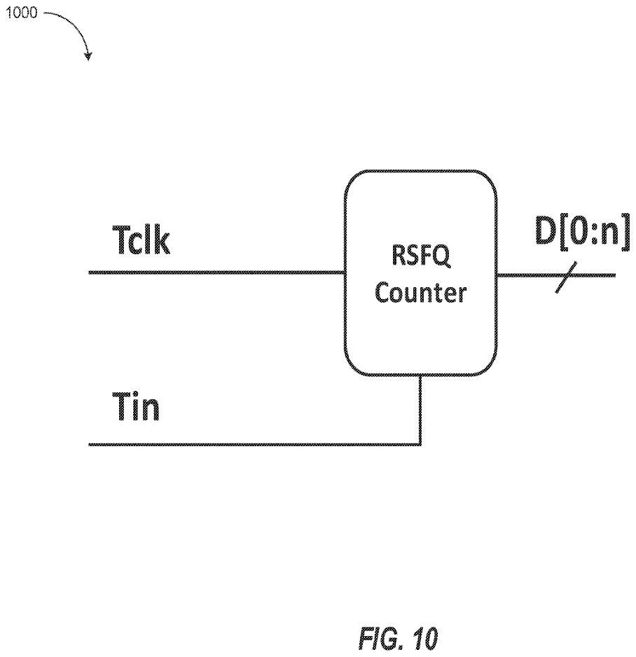

FIG. 10 is a block diagram illustrating an example converter 1000, in accordance with some embodiments of the disclosure. As discussed above, one or more of the components in RSFQ superconducting circuit may use race logic, or some other temporal based encoding for data (e.g., an encoding where the number of pulses received during a period of time indicates a value). However, some of the components in the RSFQ superconducting circuit may not use race logic, or components coupled to the RSFQ superconducting circuit may not use race logic.

In one embodiment, the converter 1000 may receive a pulse, packet, data, etc., that uses a race logic format or encoding at the input Tin. The converter 1000 may convert the pulse/packet into a binary format. The converter 1000 may include an input reference clock Telk which feeds into an RSFQ counter. The input signal for this circuit is a “Telk” clock signal which starts the counter and the reset signal is the time-domain signal Tin (e.g., a race logic packet or pulse received at a time slot).

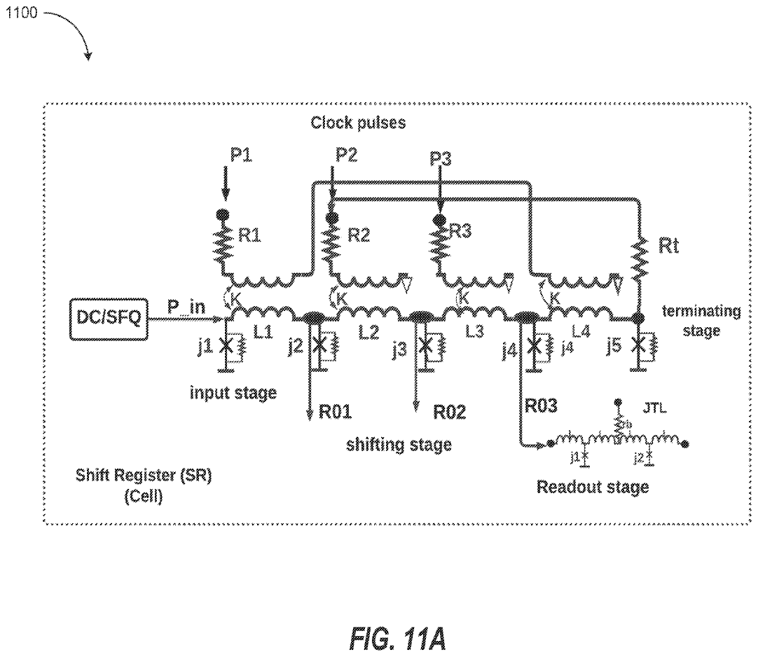

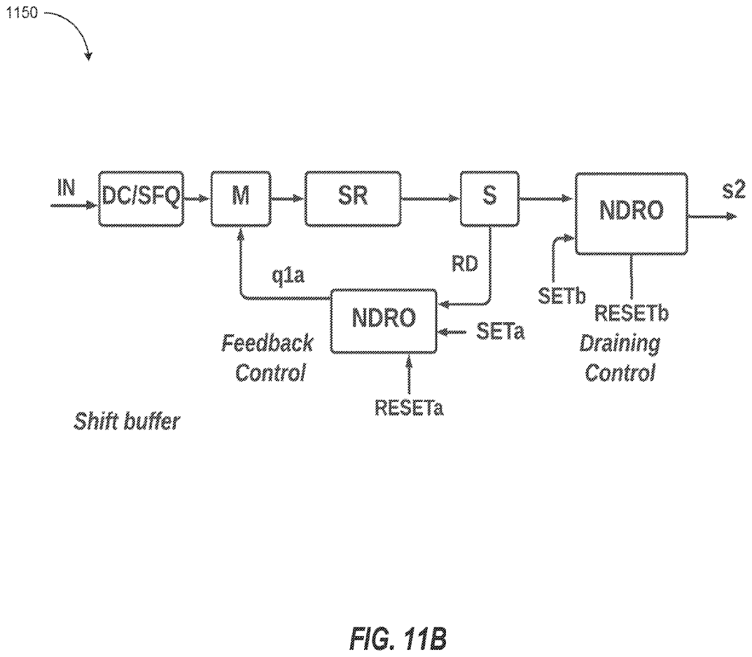

FIG. 11A is a diagram illustrating an example shift register 1100, in accordance with some embodiments of the disclosure. As discussed above, a routing network may route packets, pulses, data, etc., between sending devices and receiving device. The routing network may not buffer the pulses, packets, etc., that are routed through the routing network. However, the sending devices and/or the receiving devices may need to buffer packets/pulses if they are not ready to transmit and/or receive packets/pulses. The shift register 1100 includes resistors, inductors, Josephson junctions (JJs), and a DC-to-SFQ circuit (DCSFQ).

The shift register 1100 includes four stages. The first stage may be an input state where an input DC pulse is provided to the DCSFQ to be converted into SFQ pulses. The second stage is the shifting stage which includes three magnetically coupled interferometers. The resistor Rs1 through Rs2 may be bias resistors connected to the input pulses. There are three input ports for the 3 clock currents that determine the shifting.

The third stage is a readout stage which includes a Josephson transmission line (JTL). The JTL is used for signal amplification at to deliver the output pulse. The last stage is the terminating state. The terminating stage includes a coupled, inductor, JJs and a resistor Rt. The three input clock pulses can be tuned in to the desired shifting interval.

FIG. 11B is a diagram illustrating an example shift buffer 1150, in accordance with some embodiments of the disclosure. The shift buffer includes, DC-to-SFQ (DCSFQ), a merger (M), a shift register (SR), a splitter(S), and two non-destructive read-out (NDRO) cells. The bottom NDRO cell maybe used for the feedback loop to control the propagation of the feedback pulses. At the shift register output is a splitter and another NDRO that may control when pulses in the shift register propagate to the output after they traverse the last stage of the shift register. The shift buffer 1150 may be used to store RL-encoded pulses. The design of the shift buffer 1150 may be useful for temporarily and inexpensively storing information (e.g., buffering or storing the data for a period of time) in encoding using race logic (or some other temporal based encoding).

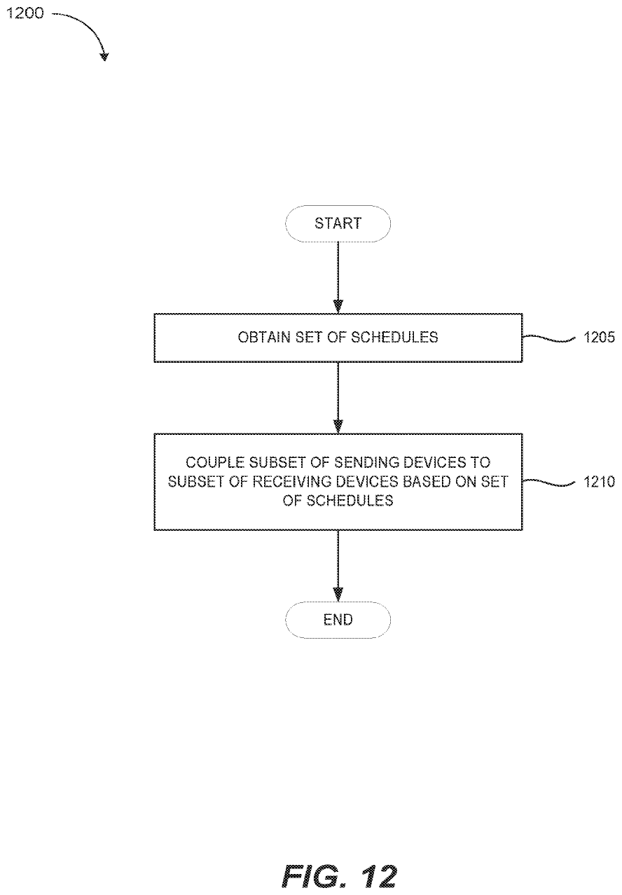

FIG. 12 is a flow diagram of a method 1200 of routing packets/pulses, in accordance with some embodiments of the disclosure. Method 1200 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 1200 may be performed by one or more of a routing network, a routing device, and a scheduling device.

With reference to FIG. 12, method 1200 illustrates example functions used by various embodiments. Although specific function blocks (“blocks”) are disclosed in method 1200, such blocks are examples. That is, embodiments are well suited to performing various other blocks or variations of the blocks recited in method 1200. It is appreciated that the blocks in method 1200 may be performed in an order different than presented, and that not all of the blocks in method 1200 may be performed.

Method 1200 begins at block 1205, where the processing logic may obtain a set of schedules routing packets between a set of sending devices and set of receiving devices. One or more of the routing network, the set of sending devices, and the set of receiving devices are part of a superconducting device. The set of sending devices and the set of receiving devices use a race logic architecture, as discussed above. At block 1210, the processing logic may couple a subset of the set of sending devices to a subset of the set of receiving devices based on the set of schedules. For example, using a round robin schedule, each routing device of a routing network may cycle through a set of sending devices and cycle through a set of receiving devices.

Appendix A includes various diagrams that describe systems, architectures, modules, components, technologies, etc., that may be used to route data between sending devices and receiving devices. Appendix A is hereby incorporated by reference in its entirety.

Unless specifically stated otherwise, terms such as “receiving,” “transmitting,” “sending,” “connecting,” “interconnecting,” “routing,” “forwarding,” “scheduling,” “generating,” “obtaining,” “determining,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. An apparatus, comprising:
a routing network to route packets between a set of sending devices and a set of receiving devices, wherein:
one or more of the routing network, the set of sending devices, and the set of receiving devices are part of a superconducting device;
the set of sending devices and the set of receiving devices use a race logic architecture; and
a scheduling module to interconnect different subsets of the set of sending devices to different subsets of the set of receiving devices based on a set of connection schedules, wherein the packets are routed between the different subsets of the set of sending devices and the different subsets of the set of receiving devices based on the set of connection schedules.

2. The apparatus of claim 1, wherein:
each connection schedule of the set of connection schedules is divided into a set of windows; and
each window is divided into a set of time slots.

3. The apparatus of claim 2, wherein a values of a packet are based on a window when the packet was received.

4. The apparatus of claim 2, wherein each of the different subsets of the set of sending devices and the different subsets of the set of receiving devices are associated with a respective window of the set of windows.

5. The apparatus of claim 1, wherein the set of connection schedules rotate between the set of sending devices and the set of receiving devices in a round robin schedule.

6. The apparatus of claim 1, wherein:
the scheduling module comprises a set of scheduling devices; and
each scheduling device of the set of scheduling devices is associated with a respective subset of the routing network.

7. The apparatus of claim 6, wherein each scheduling device of the set of scheduling devices comprises a set of merging circuits and a set of toggle flip flop (TFF) circuits.

8. The apparatus of claim 1, wherein each routing device of the routing network comprises a nondestructive read out (NDRO) cell.

9. The apparatus of claim 8, wherein each NDRO cell is to generated a respective output based on one connection schedule of the set of connection schedules.

10. The apparatus of claim 1, further comprising:
one or more shift buffers coupled to one or more of the set of sending devices and the set of receiving devices, wherein the one or more shift buffers are configured to store the packets for a period of time.

11. A system, comprising:
a set of sending devices to transmit packets;
a set of receiving devices to receive the packets;
a routing network to route the packets between the set of sending devices and the set of receiving devices, wherein:
one or more of the routing network, the set of sending devices, and the set of receiving devices are part of a superconducting device;
the set of sending devices and the set of receiving devices use a race logic architecture; and
a scheduling module to interconnect different subsets of the set of sending devices to different subsets of the set of receiving devices based on a set of connection schedules, wherein the packets are routed between the different subsets of the set of sending devices and the different subsets of the set of receiving devices based on the set of connection schedules.

12. The system of claim 11, wherein:
each connection schedule of the set of connection schedules is divided into a set of windows; and
each window is divided into a set of time slots.

13. The system of claim 12, wherein a values of a packet are based on a window when the packet was received.

14. The system of claim 12, wherein each of the different subsets of the set of sending devices and the different subsets of the set of receiving devices are associated with a respective window of the set of windows.

15. The system of claim 11, wherein the set of connection schedules rotate between the set of sending devices and the set of receiving devices in a round robin schedule.

16. The system of claim 11, wherein:
the scheduling module comprises a set of scheduling devices; and
each scheduling device of the set of scheduling devices is associated with a respective subset of the routing network.

17. The system of claim 16, wherein each scheduling device of the set of scheduling devices comprises a set of merging circuits and a set of toggle flip flop (TFF) circuits.

18. The system of claim 11, wherein each routing device of the routing network comprises a nondestructive read out (NDRO) cell.

19. The system of claim 18, wherein each NDRO cell is to generated a respective output based on one connection schedule of the set of connection schedules.

20. A method, comprising:
obtaining a set of schedules for a routing network to route packets between a set of sending devices and set of receiving devices, wherein:
one or more of the routing network, the set of sending devices, and the set of receiving devices are part of a superconducting device;
the set of sending devices and the set of receiving devices use a race logic architecture; and
coupling a subset of the set of sending devices to a subset of the set of receiving devices based on the set of schedules.
